(19) United States
(12) Patent Application Publication
(10) Pub. No.: US 2024/0064820 A1
(43) Pub. Date: Feb. 22, 2024

(54) SYSTEMS AND METHODS FOR VALIDATION OF A RANDOM ACCESS CHANNEL OCCASION

(71) Applicant: ZTE CORPORATION, Shenzhen (CN)

(72) Inventors: Juan LIU, Shenzhen (CN); Li TIAN, Shenzhen (CN); Li ZHANG, Shenzhen (CN)

(73) Assignee: ZTE CORPORATION, Shenzhen (CN)

(21) Appl. No.: 18/458,971

(22) Filed: Aug. 30, 2023

Related U.S. Application Data
(63) Continuation of application No. PCT/CN2021/107668, filed on Jul. 21, 2021.

(51) Int. Cl. H04W 74/08; H04L 5/14

(52) U.S. Cl. CPC H04W 74/0833; H04L 5/1469

(57) ABSTRACT

Presented are systems and methods for validating a random access channel (RACH) occasion. A wireless communication device may receive a RACH signaling from a wireless communication node. The wireless communication device may determine whether a time-division duplex (TDD) common configuration is received at the wireless communication device.

### CROSS-REFERENCE TO RELATED APPLICATION

This application claims the benefit of priority under 35 U.S.C. § 120 as a continuation of PCT Patent Application No. PCT/CN2021/107668, filed on Jul. 21, 2021, the disclosure of which is incorporated herein by reference in its entirety.

### TECHNICAL FIELD

The disclosure relates generally to wireless communications, including but not limited to systems and methods for validating a random access channel (RACH) occasion.

### BACKGROUND

The standardization organization Third Generation Partnership Project (3GPP) is currently in the process of specifying a new Radio Interface called 5G New Radio (5G NR) as well as a Next Generation Packet Core Network (NG-CN or NGC). The 5G NR will have three main components: a 5G Access Network (5G-AN), a 5G Core Network (5GC), and a User Equipment (UE). In order to facilitate the enablement of different data services and requirements, the elements of the 5GC, also called Network Functions, have been simplified with some of them being software based, and some being hardware based, so that they could be adapted according to need.

### SUMMARY

The example embodiments disclosed herein are directed to solving the issues relating to one or more of the problems presented in the prior art, as well as providing additional features that will become readily apparent by reference to the following detailed description when taken in conjunction with the accompany drawings. In accordance with various embodiments, example systems, methods, devices and computer program products are disclosed herein. It is understood, however, that these embodiments are presented by way of example and are not limiting, and it will be apparent to those of ordinary skill in the art who read the present disclosure that various modifications to the disclosed embodiments can be made while remaining within the scope of this disclosure.

At least one aspect is directed to a system, method, apparatus, or a computer-readable medium. A wireless communication device (e.g., a UE) may receive a RACH signaling from a wireless communication node. The wireless communication device may determine whether a time-division duplex (TDD) common configuration is received at the wireless communication device.

In some embodiments, the wireless communication device may determine whether a RACH occasion (RO) is valid if the TDD common configuration is received. The wireless communication device may determine whether the RO is valid, if no TDD common configuration is received. In some embodiments, the RO may straddle a physical RACH (PRACH) slot boundary between a first PRACH slot and a second PRACH slot following the first PRACH slot. If the RO straddles the PRACH slot boundary between the first PRACH slot and the second PRACH slot, the wireless communication device may determine that the RO is valid if the second PRACH slot is an uplink (UL) slot or each symbol occupied by the RO in the second slot is an UL symbol. If the RO straddles the PRACH slot boundary between the first PRACH slot and the second PRACH slot, the wireless communication device may determine that the RO is valid if the RO has a first symbol in the first PRACH slot and each symbol occupied by the RO in the second PRACH slot is an UL symbol. If the RO straddles the PRACH slot boundary between the first PRACH slot and the second PRACH slot, the wireless communication device may determine that the RO is valid if a first symbol of the RO is at least N_{gap} symbols after a last downlink (DL) symbol, and at least N_{gap} symbols after a last synchronization signal or physical broadcast channel (SS/PBCH) block symbol. In some embodiments, N_{gap} may be an integer value greater than or equal to 0

If the RO straddles the PRACH slot boundary between the first PRACH slot and the second PRACH slot, the wireless communication device may determine that the RO is invalid if the second PRACH slot is a downlink (DL) slot or any symbol occupied by the RO in the second slot is a DL symbol. If the RO straddles the PRACH slot boundary between the first PRACH slot and the second PRACH slot, the wireless communication device may determine that the RO is invalid if a first symbol of the RO is less than N_{gap} symbols after a last DL symbol, or less than N_{gap} symbols after a last SS/PBCH block symbol. If the RO straddles the PRACH slot boundary between the first PRACH slot and the second PRACH slot, the wireless communication device may determine that the RO is invalid if the RO has a first symbol in the first PRACH slot and any symbol occupied by the RO in the second PRACH slot is a DL symbol. If the RO straddles the PRACH slot boundary between the first PRACH slot and the second PRACH slot, the wireless communication device may determine that the RO is valid. If the RO straddles the PRACH slot boundary between the first PRACH slot and the second PRACH slot, the wireless communication device may determine that the RO is invalid.

In some embodiments, the RO may be located beyond a first PRACH slot in a second PRACH slot following the first PRACH slot. If the RO is located beyond the first PRACH slot in the second PRACH slot following the first PRACH slot, the wireless communication device may determine that the RO is valid if the second PRACH slot is an uplink (UL) slot or each symbol occupied by the RO in the second slot is an UL symbol. If the RO is located beyond the first PRACH slot in the second PRACH slot following the first PRACH slot, the wireless communication device may determine that the RO is valid if a first symbol of the RO is at least N_{gap} symbols after a last downlink (DL) symbol, and at least N_{gap} symbols after a last synchronization signal or physical broadcast channel (SS/PBCH) block symbol. In some embodiments, N_{gap} may be an integer value greater than or equal to 0.

If the RO is located beyond the first PRACH slot in the second PRACH slot following the first PRACH slot, the wireless communication device may determine that the RO is invalid if a first symbol of the RO is less than N_{gap} symbols after a last DL symbol, or less than N_{gap} symbols after a last SS/PBCH block symbol. If the RO is located beyond the first PRACH slot in the second PRACH slot following the first PRACH slot, the wireless communication device may determine that the RO is invalid if the second PRACH slot is a DL slot or any symbol occupied by the RO in the second slot is a DL symbol. If the RO is located beyond the first PRACH slot in the second PRACH slot following the first PRACH slot, the wireless communication device may determine that the RO is valid. If the RO is located beyond the first PRACH slot in the second PRACH slot following the first PRACH slot, the wireless communication device may determine that the RO is invalid.

At least one aspect is directed to a system, method, apparatus, or a computer-readable medium. A wireless communication node (e.g., a ground terminal, a base station, a gNB, an eNB, or a serving node) may transmit a RACH signaling to a wireless communication device. The wireless communication device may determine whether a RACH occasion (RO) is valid if a time-division duplex (TDD) common configuration is received. The wireless communication device may determine whether the RO is valid if no TDD common configuration is received.

### BRIEF DESCRIPTION OF THE DRAWINGS

Various example embodiments of the present solution are described in detail below with reference to the following figures or drawings. The drawings are provided for purposes of illustration only and merely depict example embodiments of the present solution to facilitate the reader's understanding of the present solution. Therefore, the drawings should not be considered limiting of the breadth, scope, or applicability of the present solution. It should be noted that for clarity and ease of illustration, these drawings are not necessarily drawn to scale.

FIG. 1 illustrates an example cellular communication network in which techniques disclosed herein may be implemented, in accordance with an embodiment of the present disclosure;

FIG. 2 illustrates a block diagram of an example base station and a user equipment device, in accordance with some embodiments of the present disclosure;

FIG. 3 illustrates example configurations for a PRACH Config. Index, in accordance with some embodiments of the present disclosure;

FIGS. 4-5 illustrates example configurations for a PRACH slot, in accordance with some embodiments of the present disclosure;

FIGS. 7-9 illustrates example configurations for one or more PRACH slots with one or more gaps, in accordance with some embodiments of the present disclosure; and

FIG. 10 illustrates a flow diagram of an example method for validating a random access channel (RACH) occasion, in accordance with an embodiment of the present disclosure.

### DETAILED DESCRIPTION

### 1. Mobile Communication Technology and Environment

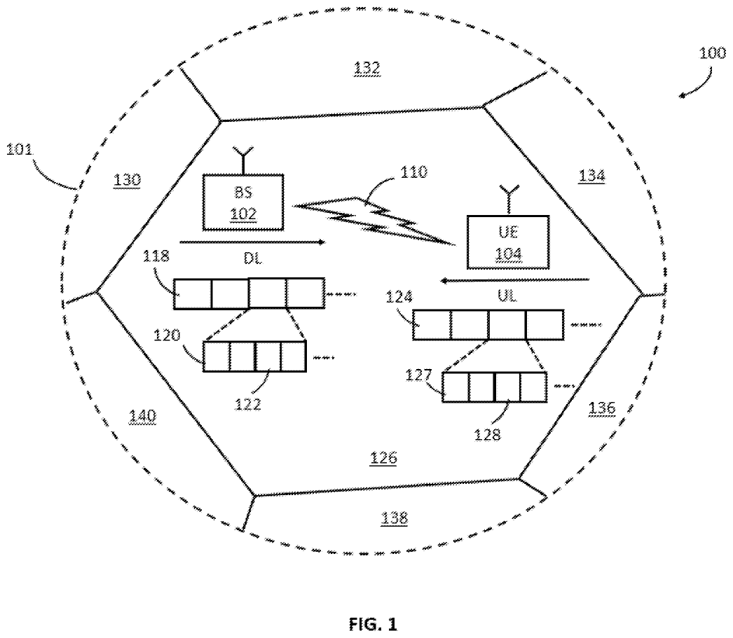

FIG. 1 illustrates an example wireless communication network, and/or system, 100 in which techniques disclosed herein may be implemented, in accordance with an embodiment of the present disclosure. In the following discussion, the wireless communication network 100 may be any wireless network, such as a cellular network or a narrowband Internet of things (NB-IoT) network, and is herein referred to as “network 100.” Such an example network 100 includes a base station 102 (hereinafter “BS 102”; also referred to as wireless communication node) and a user equipment device 104 (hereinafter “UE 104”; also referred to as wireless communication device) that can communicate with each other via a communication link 110 (e.g., a wireless communication channel), and a cluster of cells 126, 130, 132, 134, 136, 138 and 140 overlaying a geographical area 101. In FIG. 1, the BS 102 and UE 104 are contained within a respective geographic boundary of cell 126. Each of the other cells 130, 132, 134, 136, 138 and 140 may include at least one base station operating at its allocated bandwidth to provide adequate radio coverage to its intended users.

For example, the BS 102 may operate at an allocated channel transmission bandwidth to provide adequate coverage to the UE 104. The BS 102 and the UE 104 may communicate via a downlink radio frame 118, and an uplink radio frame 124 respectively. Each radio frame 118/124 may be further divided into sub-frames 120/127 which may include data symbols 122/128. In the present disclosure, the BS 102 and UE 104 are described herein as non-limiting examples of “communication nodes,” generally, which can practice the methods disclosed herein. Such communication nodes may be capable of wireless and/or wired communications, in accordance with various embodiments of the present solution.

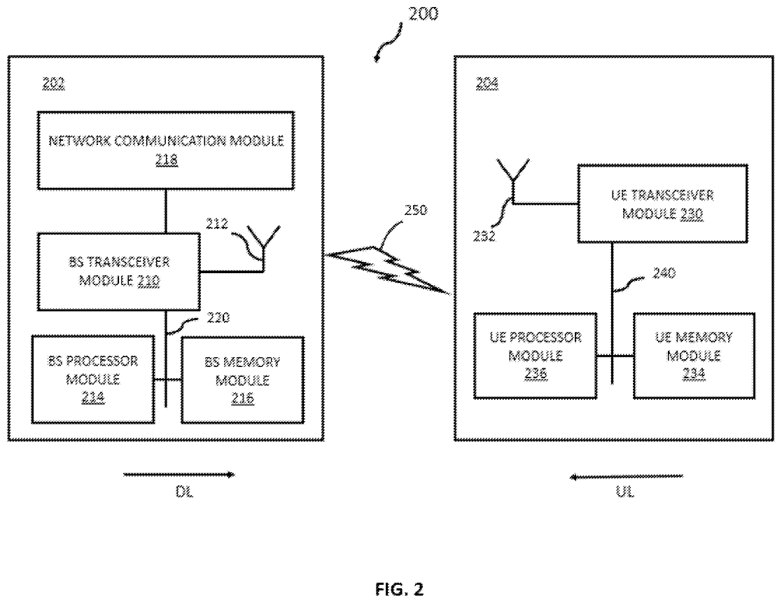

FIG. 2 illustrates a block diagram of an example wireless communication system 200 for transmitting and receiving wireless communication signals (e.g., OFDM/OFDMA signals) in accordance with some embodiments of the present solution. The system 200 may include components and elements configured to support known or conventional operating features that need not be described in detail herein. In one illustrative embodiment, system 200 can be used to communicate (e.g., transmit and receive) data symbols in a wireless communication environment such as the wireless communication environment 100 of FIG. 1, as described above.

System 200 generally includes a base station 202 (hereinafter “BS 202”) and a user equipment device 204 (hereinafter “UE 204”). The BS 202 includes a BS (base station) transceiver module 210, a BS antenna 212, a BS processor module 214, a BS memory module 216, and a network communication module 218, each module being coupled and interconnected with one another as necessary via a data communication bus 220. The UE 204 includes a UE (user equipment) transceiver module 230, a UE antenna 232, a UE memory module 234, and a UE processor module 236, each module being coupled and interconnected with one another as necessary via a data communication bus 240. The BS 202 communicates with the UE 204 via a communication channel 250, which can be any wireless channel or other medium suitable for transmission of data as described herein.

As would be understood by persons of ordinary skill in the art, system 200 may further include any number of modules other than the modules shown in FIG. 2. Those skilled in the art will understand that the various illustrative blocks, modules, circuits, and processing logic described in connection with the embodiments disclosed herein may be implemented in hardware, computer-readable software, firmware, or any practical combination thereof. To clearly illustrate this interchangeability and compatibility of hardware, firmware, and software, various illustrative components, blocks, modules, circuits, and steps are described generally in terms of their functionality. Whether such functionality is implemented as hardware, firmware, or software can depend upon the particular application and design constraints imposed on the overall system. Those familiar with the concepts described herein may implement such functionality in a suitable manner for each particular application, but such implementation decisions should not be interpreted as limiting the scope of the present disclosure

In accordance with some embodiments, the UE transceiver 230 may be referred to herein as an “uplink” transceiver 230 that includes a radio frequency (RF) transmitter and a RF receiver each comprising circuitry that is coupled to the antenna 232. A duplex switch (not shown) may alternatively couple the uplink transmitter or receiver to the uplink antenna in time duplex fashion. Similarly, in accordance with some embodiments, the BS transceiver 210 may be referred to herein as a “downlink” transceiver 210 that includes a RF transmitter and a RF receiver each comprising circuitry that is coupled to the antenna 212. A downlink duplex switch may alternatively couple the downlink transmitter or receiver to the downlink antenna 212 in time duplex fashion. The operations of the two transceiver modules 210 and 230 may be coordinated in time such that the uplink receiver circuitry is coupled to the uplink antenna 232 for reception of transmissions over the wireless transmission link 250 at the same time that the downlink transmitter is coupled to the downlink antenna 212. Conversely, the operations of the two transceivers 210 and 230 may be coordinated in time such that the downlink receiver is coupled to the downlink antenna 212 for reception of transmissions over the wireless transmission link 250 at the same time that the uplink transmitter is coupled to the uplink antenna 232. In some embodiments, there is close time synchronization with a minimal guard time between changes in duplex direction.

The UE transceiver 230 and the base station transceiver 210 are configured to communicate via the wireless data communication link 250, and cooperate with a suitably configured RF antenna arrangement 212/232 that can support a particular wireless communication protocol and modulation scheme. In some illustrative embodiments, the UE transceiver 210 and the base station transceiver 210 are configured to support industry standards such as the Long Term Evolution (LTE) and emerging 5G standards, and the like. It is understood, however, that the present disclosure is not necessarily limited in application to a particular standard and associated protocols. Rather, the UE transceiver 230 and the base station transceiver 210 may be configured to support alternate, or additional, wireless data communication protocols, including future standards or variations thereof.

In accordance with various embodiments, the BS 202 may be an evolved node B (eNB), a serving eNB, a target eNB, a femto station, or a pico station, for example. In some embodiments, the UE 204 may be embodied in various types of user devices such as a mobile phone, a smart phone, a personal digital assistant (PDA), tablet, laptop computer, wearable computing device, etc. The processor modules 214 and 236 may be implemented, or realized, with a general purpose processor, a content addressable memory, a digital signal processor, an application specific integrated circuit, a field programmable gate array, any suitable programmable logic device, discrete gate or transistor logic, discrete hardware components, or any combination thereof, designed to perform the functions described herein. In this manner, a processor may be realized as a microprocessor, a controller, a microcontroller, a state machine, or the like. A processor may also be implemented as a combination of computing devices, e.g., a combination of a digital signal processor and a microprocessor, a plurality of microprocessors, one or more microprocessors in conjunction with a digital signal processor core, or any other such configuration.

Furthermore, the steps of a method or algorithm described in connection with the embodiments disclosed herein may be embodied directly in hardware, in firmware, in a software module executed by processor modules 214 and 236, respectively, or in any practical combination thereof. The memory modules 216 and 234 may be realized as RAM memory, flash memory, ROM memory, EPROM memory, EEPROM memory, registers, a hard disk, a removable disk, a CD-ROM, or any other form of storage medium known in the art. In this regard, memory modules 216 and 234 may be coupled to the processor modules 210 and 230, respectively, such that the processors modules 210 and 230 can read information from, and write information to, memory modules 216 and 234, respectively. The memory modules 216 and 234 may also be integrated into their respective processor modules 210 and 230. In some embodiments, the memory modules 216 and 234 may each include a cache memory for storing temporary variables or other intermediate information during execution of instructions to be executed by processor modules 210 and 230, respectively. Memory modules 216 and 234 may also each include non-volatile memory for storing instructions to be executed by the processor modules 210 and 230, respectively.

The network communication module 218 generally represents the hardware, software, firmware, processing logic, and/or other components of the base station 202 that enable bi-directional communication between base station transceiver 210 and other network components and communication nodes configured to communication with the base station 202. For example, network communication module 218 may be configured to support internet or WiMAX traffic. In a typical deployment, without limitation, network communication module 218 provides an 802.3 Ethernet interface such that base station transceiver 210 can communicate with a conventional Ethernet based computer network. In this manner, the network communication module 218 may include a physical interface for connection to the computer network (e.g., Mobile Switching Center (MSC)). The terms “configured for,” “configured to” and conjugations thereof, as used herein with respect to a specified operation or function, refer to a device, component, circuit, structure, machine, signal, etc., that is physically constructed, programmed, formatted and/or arranged to perform the specified operation or function.

The Open Systems Interconnection (OSI) Model (referred to herein as, “open system interconnection model”) is a conceptual and logical layout that defines network communication used by systems (e.g., wireless communication device, wireless communication node) open to interconnection and communication with other systems. The model is broken into seven subcomponents, or layers, each of which represents a conceptual collection of services provided to the layers above and below it. The OSI Model also defines a logical network and effectively describes computer packet transfer by using different layer protocols. The OSI Model may also be referred to as the seven-layer OSI Model or the seven-layer model. In some embodiments, a first layer may be a physical layer. In some embodiments, a second layer may be a Medium Access Control (MAC) layer. In some embodiments, a third layer may be a Radio Link Control (RLC) layer. In some embodiments, a fourth layer may be a Packet Data Convergence Protocol (PDCP) layer. In some embodiments, a fifth layer may be a Radio Resource Control (RRC) layer. In some embodiments, a sixth layer may be a Non Access Stratum (NAS) layer or an Internet Protocol (IP) layer, and the seventh layer being the other layer.

Various example embodiments of the present solution are described below with reference to the accompanying figures to enable a person of ordinary skill in the art to make and use the present solution. As would be apparent to those of ordinary skill in the art, after reading the present disclosure, various changes or modifications to the examples described herein can be made without departing from the scope of the present solution. Thus, the present solution is not limited to the example embodiments and applications described and illustrated herein. Additionally, the specific order or hierarchy of steps in the methods disclosed herein are merely example approaches. Based upon design preferences, the specific order or hierarchy of steps of the disclosed methods or processes can be re-arranged while remaining within the scope of the present solution. Thus, those of ordinary skill in the art will understand that the methods and techniques disclosed herein present various steps or acts in a sample order, and the present solution is not limited to the specific order or hierarchy presented unless expressly stated otherwise.

### 2. Systems and Methods for Validation of a Random Access Channel Occasion

In certain systems with high carrier frequencies (e.g., 5G new radio (NR), Next Generation (NG) systems, 3GPP systems, and/or other systems), a channel bandwidth of said systems may increase (e.g., be wider). For instance, a channel bandwidth of a 5G NR system may be larger than a channel bandwidth of a Long Term Evolution (LTE) system (e.g., a 5G NR system can include/use higher carrier frequencies compared to a LTE system). Systems with higher carrier frequencies may use, include, and/or introduce a new/distinct subcarrier spacing. In addition, said systems (e.g., systems with higher carrier frequencies) may use, include, and/or introduce a gap (e.g., a time-instance/domain gap, such as a number of symbols). In some embodiments, one or more processes can use said gap, such as for (or to support/enable) a look before talk (LBT) process, a beam (e.g., direction) switching process, and/or a physical random access channel (PRACH) process (otherwise sometimes referred to as a random access channel (RACH) process). For instance, in a PRACH process, the gap can be inserted/introduced in between RACH occasions (RO). In some embodiments, a RO may straddle, span, and/or extend across a PRACH slot boundary (otherwise referred to as a RACH slot boundary). If a RO straddles a PRACH slot boundary, a wireless communication device (e.g., a UE, a terminal, or a served node) may determine whether said RO is valid or invalid.

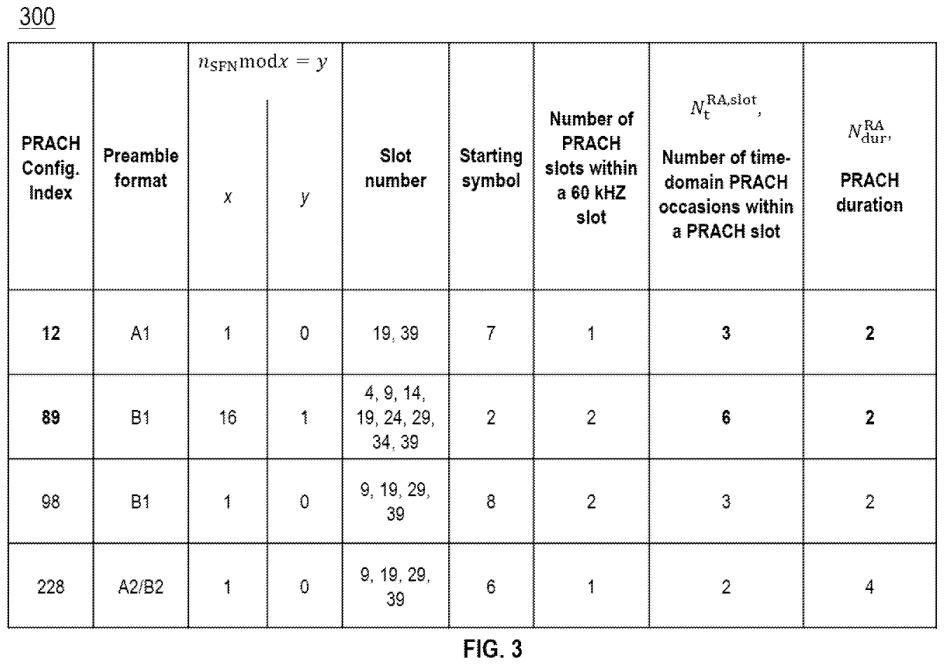

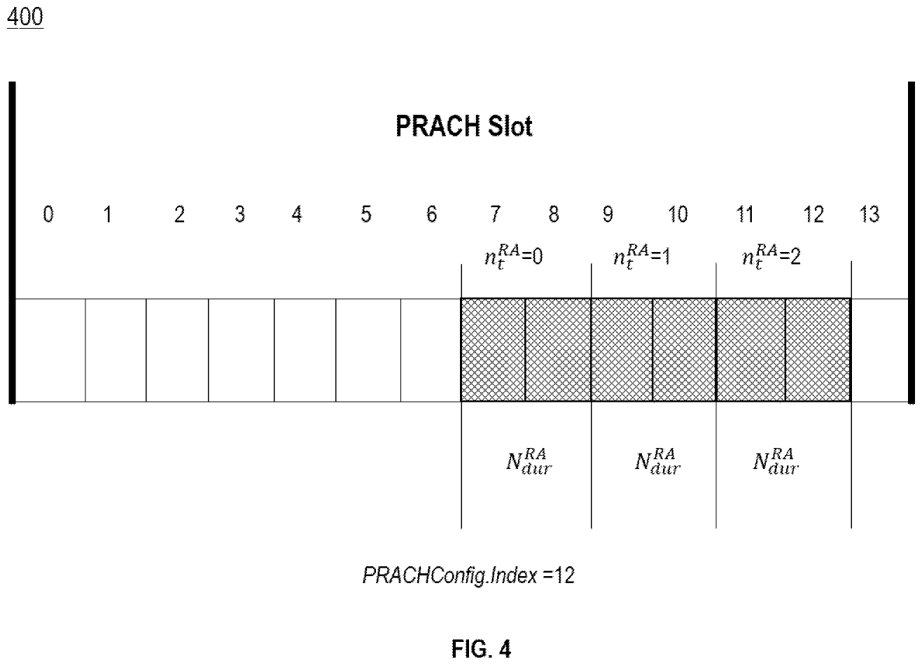

Certain systems (e.g., 5G NR systems, Next Generation (NG) systems, and/or other systems) may use at least one PRACH indicator and/or index (e.g., a PRACH Config. Index) to configure one or more ROs. Referring now to FIG. 3, depicted is a configuration 300 of an embodiment for a PRACH Config. Index (which may be referred as a configuration index or a PRACH/RACH configuration index). According to FIG. 3, a value of a PRACH Config. Index may indicate/specify a starting symbol of a RO within a PRACH slot, a number of PRACH slots within a 60 kHz (or other frequencies) slot, a number of time-domain ROs within a PRACH slot, and/or a duration of a PRACH (e.g., a number of symbols per RO). Referring now to FIG. 4, depicted is a configuration 400 of an embodiment of a PRACH slot, according to a value of a PRACH Config. Index. As shown in FIG. 4, a PRACH Config. Index with a value of 12 may indicate/specify that a starting symbol has a value of seven (e.g., an RO begins at the eighth symbol of the PRACH slot) and/or a PRACH duration has a value of two symbols (e.g., a duration of each RO is two symbols). In addition, a PRACH Config. Index with a value of 12 may indicate/specify that a PRACH slot includes three time-domain ROs (e.g., three time-domain ROs per PRACH slot), as shown in FIG. 4.

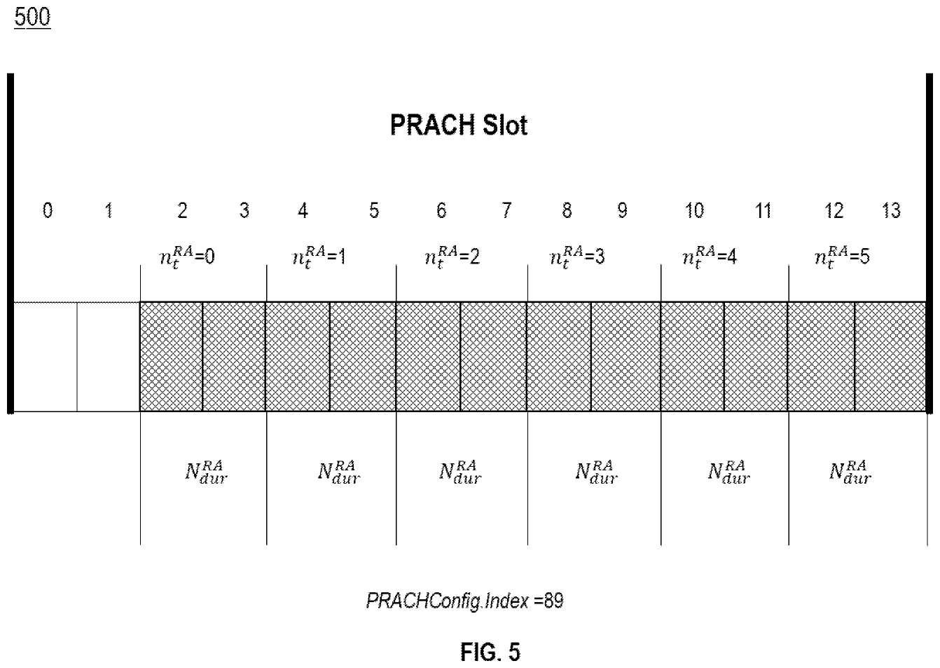

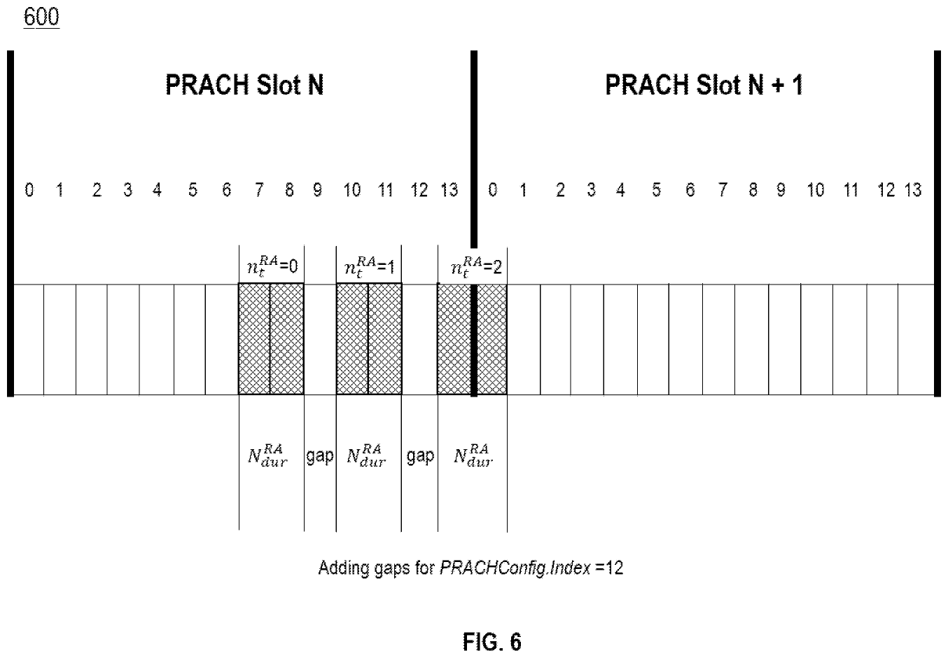

Referring now to FIG. 5, depicted is a configuration 500 of an embodiment of a PRACH slot, according to a value of a PRACH Config. Index. As shown in FIG. 5, a PRACH Config. Index with a value of 89 may specify that a starting symbol has a value of two, a PRACH duration is two symbols, and/or a PRACH slot includes six time-domain ROs. In some embodiments, one or more parameters of a higher layer (e.g., RACH-ConfigCommon, RACH-ConfigDedicated, RACH-ConfigGeneric, and/or other parameters) may configure/determine the PRACH Config. Index (and/or other indices). In some embodiments, one or more ROs (e.g., all ROs) can be located within a single PRACH slot. As such, an RO (of the one or more ROs) may not straddle, span, and/or extend across a PRACH slot boundary (e.g., a PRACH slot boundary between a first PRACH slot and a second PRACH slot) and/or into another PRACH slot (e.g., from a first PRACH slot into a second PRACH slot).

In some embodiments, at least one gap (e.g., a time instance, such as a gap with a length of one or more symbols, for instance) can be located/introduced within a PRACH pattern of a PRACH slot, such as between ROs. If at least one gap is located/introduced within the PRACH pattern/configuration (e.g., a PRACH pattern/configuration specified by the PRACH Config. Index), one or more ROs of the PRACH slot can be located/displaced outside of said PRACH slot (e.g., instead of being located within a same PRACH slot).

A. Configuration of PRACH Slots when a PRACH Config. Index=12

In some embodiments, a PRACH Config. Index may have a value of 12. According to FIG. 3, for example, if a PRACH Config. Index has a value of 12, a starting symbol may include or correspond to seven (e.g., an eighth symbol), and/or each PRACH (e.g., a RO) may have a duration of two symbols. In addition, if a PRACH Config. Index has a value of 12, a PRACH slot may include three time-domain ROs within said PRACH slot. In some embodiments, a gap with a length of one symbol (as shown in FIG. 6) can be used, included, and/or introduced into a PRACH pattern/configuration, wherein the PRACH pattern is determined/specified by the value of the PRACH Config. Index (e.g., PRACH Config. Index=12). If a gap with a length of one symbol is used and/or a PRACH Config. Index has a value of 12, at least one RO (for instance, a third RO) may straddle and/or extend across a PRACH slot boundary. The PRACH slot boundary can be a PRACH slot boundary between a first PRACH slot (e.g., slot N) and a second PRACH slot (e.g., slot N+1).
Case 1: In some embodiments, a wireless communication device may determine that the third RO (and/or other ROs straddling a PRACH slot boundary) is valid. For instance, if the second PRACH slot (e.g., slot N+1) is an uplink (UL) slot and/or each symbol occupied by the RO in the second PRACH slot is an UL symbol, the wireless communication device may determine that the third RO is valid.
Case 2: In some embodiments, a wireless communication device may determine that the third RO (and/or other ROs straddling a PRACH slot boundary) is invalid. For instance, if the second PRACH slot (e.g., slot N+1) is a downlink (DL) slot and/or any symbol occupied by the RO in the second PRACH slot is a DL symbol, the wireless communication device may determine that the third RO is invalid.
Case 3: In some embodiments, a third RO (or other ROs) can straddle a PRACH slot boundary (e.g., between a first PRACH slot and a second PRACH slot). If the third RO straddles the PRACH slot boundary (e.g., the third RO spans across a first PRACH slot and a second PRACH slot), the wireless communication device may determine that the third RO is valid. In some embodiments, a wireless communication device may combine/use Case 1 and Case 3 to determine whether an RO (e.g., the third RO) is valid.
Case 4: In some embodiments, a third RO (or other ROs) can straddle a PRACH slot boundary (e.g., between a first PRACH slot and a second PRACH slot). If the third RO straddles the PRACH slot boundary (e.g., the third RO spans across a first PRACH slot and a second PRACH slot), the wireless communication device may determine that the third RO is invalid. In some embodiments, a wireless communication device may combine/use Case 2 and Case 4 to determine whether an RO (e.g., the third RO) is invalid.

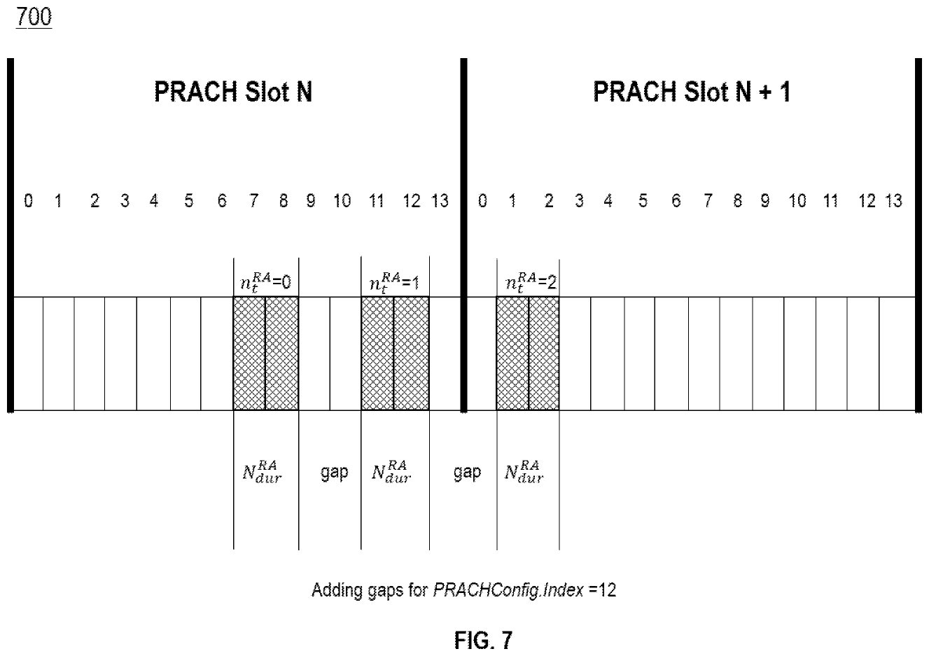

In some embodiments, a gap with a length of two symbols (as shown in FIG. 7) can be used, included, and/or introduced into a PRACH pattern/configuration, wherein the PRACH pattern is determined/specified by the value of the PRACH Config. Index (e.g., PRACH Config. Index=12). If a gap with a length of two symbols is used and/or a PRACH Config. Index has a value of 12, at least one RO (for instance, a third RO) may be located beyond and/or outside of a first PRACH slot (e.g., slot N). For instance, the at least one RO can be located in a second PRACH slot (e.g., slot N+1) following (e.g., immediately following, or more than one slot away) the first PRACH slot.
Case 1: In some embodiments, a wireless communication device may determine that the third RO (and/or other ROs located beyond and/or outside of a first PRACH slot) is valid. For instance, if the second PRACH slot (e.g., slot N+1) is an UL slot and/or the symbol(s) of the second PRACH slot occupied/used by the third RO is/are UL symbol(s), the wireless communication device may determine that the third RO is valid.
Case 1-1: In some embodiments, the wireless communication device may determine that the third RO (and/or other ROs located beyond and/or outside of a first PRACH slot) is valid if at least the second PRACH slot is an UL slot. In some embodiments, the wireless communication device may determine that the third RO (and/or other ROs located beyond and/or outside of a first PRACH slot) is valid if at least the symbol(s) of the second PRACH slot occupied/used by the third RO is/are UL symbol(s). In some embodiments, the wireless communication device may determine that the third RO is valid if a first symbol of the third RO is at least N_{gap} symbols after a last DL symbol. In some embodiments, the wireless communication device may determine that the third RO is valid if a first symbol of the third RO is at least N_{gap} symbols after a last synchronization signal or physical broadcast channel (SS/PBCH) block symbol. In some embodiments, N_{gap} can include or correspond to an integer value greater than or equal to 0 (or other values).
Case 1-2: In some embodiments, the wireless communication device may determine that the third RO (and/or other ROs located beyond and/or outside of a first PRACH slot) is invalid if at least the second PRACH slot is an UL slot. In some embodiments, the wireless communication device may determine that the third RO (and/or other ROs located beyond and/or outside of a first PRACH slot) is invalid if at least the symbol(s) of the second PRACH slot occupied/used by the third RO is/are UL symbol(s). In some embodiments, the wireless communication device may determine that the third RO is invalid if a first symbol of the third RO is less than N_{gap} symbols after a last DL symbol. In some embodiments, the wireless communication device may determine that the third RO is invalid if a first symbol of the third RO is less than N_{gap} symbols after a last SS/PBCH block symbol. In some embodiments, N_{gap} can include or correspond to an integer value greater than or equal to 0 (or other values).
Case 2: In some embodiments, a wireless communication device may determine that the third RO (and/or other ROs located beyond and/or outside of a first PRACH slot) is invalid. For instance, if the second PRACH slot (e.g., slot N+1) is a DL slot and/or any of the symbol(s) of the second PRACH slot occupied/used by the third RO is/are DL symbol(s), the wireless communication device may determine that the third RO is invalid.
Case 3: In some embodiments, a wireless communication device may determine that the third RO (and/or other ROs located beyond and/or outside of a first PRACH slot) is valid. In some embodiments, a wireless communication device may combine/use Case 1-1 and Case 3 to determine whether an RO (e.g., the third RO) is valid.
Case 4: In some embodiments, a wireless communication device may determine that the third RO (and/or other ROs located beyond and/or outside of a first PRACH slot) is invalid. For instance, the wireless communication device may determine the third RO is invalid if the third RO is located in a slot other than the first PRACH slot (e.g., the third RO is entirely located in a slot other than the first PRACH slot).
   B. Configuration of PRACH Slots when a PRACH Config. Index=89

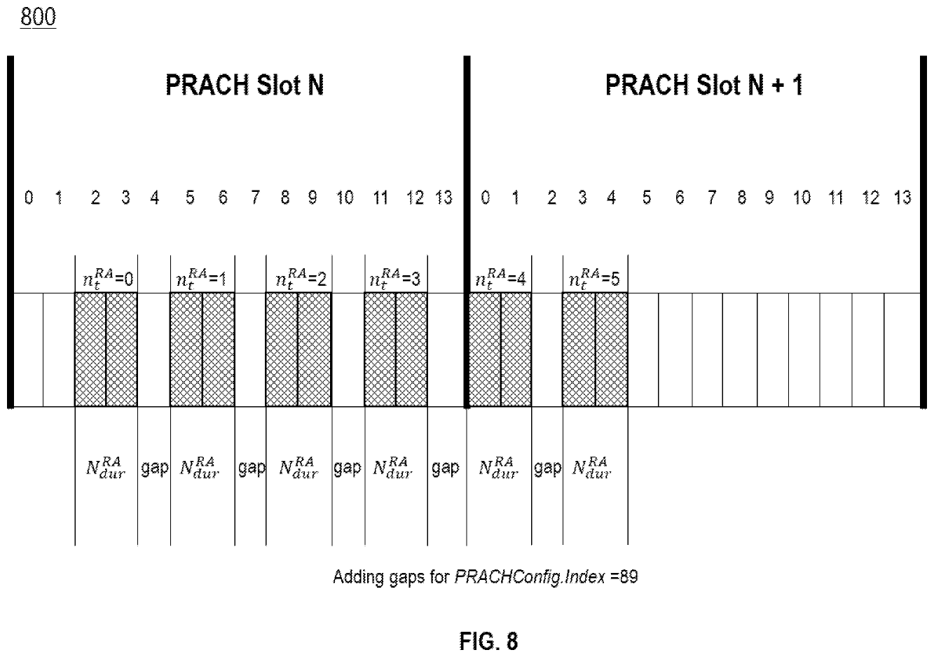

In some embodiments, a PRACH Config. Index may have a value of 89 (or other values). According to FIG. 3, for example, if a PRACH Config. Index has a value of 89, a starting symbol may include or correspond to two (e.g., a third symbol), and/or each PRACH (e.g., a RO) may have a duration of two symbols. In addition, if a PRACH Config. Index has a value of 89, a PRACH slot may include six time-domain ROs within said PRACH slot. In some embodiments, a gap with a length of one symbol (as shown in FIG. 8) can be used, included, and/or introduced into a PRACH pattern/configuration, wherein the PRACH pattern is determined/specified by the value of the PRACH Config. Index (e.g., PRACH Config. Index=89). If a gap with a length of one symbol is used and/or a PRACH Config. Index has a value of 89, at least one RO (for instance, a fifth RO and/or a sixth RO) may be located beyond and/or outside of a first PRACH slot (e.g., slot N). For instance, the at least one RO can be located in a second PRACH slot (e.g., slot N+1) following (e.g., immediately following, or more than one slot away) the first PRACH slot.
Case 1: In some embodiments, a wireless communication device may determine that the at least one RO (e.g., a fifth RO, a sixth RO, and/or other ROs located beyond and/or outside of a first PRACH slot) is valid. For instance, if the second PRACH slot (e.g., slot N+1) is an UL slot and/or each symbol(s) of the second PRACH slot occupied/used by the at least one RO is/are UL symbol(s), the wireless communication device may determine that the at least one RO is valid.
Case 1-1: In some embodiments, the wireless communication device may determine that the at least one RO (e.g., a fifth RO, a sixth RO, and/or other ROs located beyond and/or outside of a first PRACH slot) is valid if at least the second PRACH slot is an UL slot. In some embodiments, the wireless communication device may determine that the at least one RO (e.g., a fifth RO, a sixth RO, and/or other ROs located beyond and/or outside of a first PRACH slot) is valid if at least the symbol(s) of the second PRACH slot occupied/used by the at least one RO is/are UL symbol(s). In some embodiments, the wireless communication device may determine that the at least one RO is valid if a first symbol of the at least one RO is at least N_{gap} symbols after a last DL symbol. In some embodiments, the wireless communication device may determine that the at least one RO is valid if a first symbol of the at least one RO is at least N_{gap} symbols after a last SS/PBCH block symbol. In some embodiments, N_{gap} can include or correspond to an integer value greater than or equal to 0 (or other values).
Case 1-2: In some embodiments, the wireless communication device may determine that the at least one RO (e.g., a fifth RO, a sixth RO, and/or other ROs located beyond and/or outside of a first PRACH slot) is invalid if at least the second PRACH slot is an UL slot. In some embodiments, the wireless communication device may determine that the at least one RO (e.g., a fifth RO, a sixth RO, and/or other ROs located beyond and/or outside of a first PRACH slot) is invalid if at least the symbol(s) of the second PRACH slot occupied/used by the third RO is/are UL symbol(s). In some embodiments, the wireless communication device may determine that the at least one RO is invalid if a first symbol of the at least one RO is less than N_{gap} symbols after a last DL symbol. In some embodiments, the wireless communication device may determine that the at least one RO is invalid if a first symbol of the at least one RO is less than N_{gap} symbols after a last SS/PBCH block symbol. In some embodiments, N_{gap} can include or correspond to an integer value greater than or equal to 0 (or other values).
Case 2: In some embodiments, a wireless communication device may determine that the at least one RO (e.g., a fifth RO, a sixth RO, and/or other ROs located beyond and/or outside of a first PRACH slot) is invalid. For instance, if the second PRACH slot (e.g., slot N+1) is a DL slot and/or any of the symbol(s) of the second PRACH slot occupied/used by the at least one RO is/are DL symbol(s), the wireless communication device may determine that the at least one RO is invalid.
Case 3: In some embodiments, a wireless communication device may determine that the at least one RO (e.g., a fifth RO, a sixth RO, and/or other ROs located beyond and/or outside of a first PRACH slot) is valid. In some embodiments, a wireless communication device may combine/use Case 1-1 and Case 3 to determine whether the at least one RO is valid.
Case 4: In some embodiments, a wireless communication device may determine that the at least one RO (e.g., a fifth RO, a sixth RO, and/or other ROs located beyond and/or outside of a first PRACH slot)) is invalid. For instance, the wireless communication device may determine that the at least one RO is invalid if the at least one RO is located in a slot other than the first PRACH slot (e.g., the at least one RO is entirely located in a slot other than the first PRACH slot).

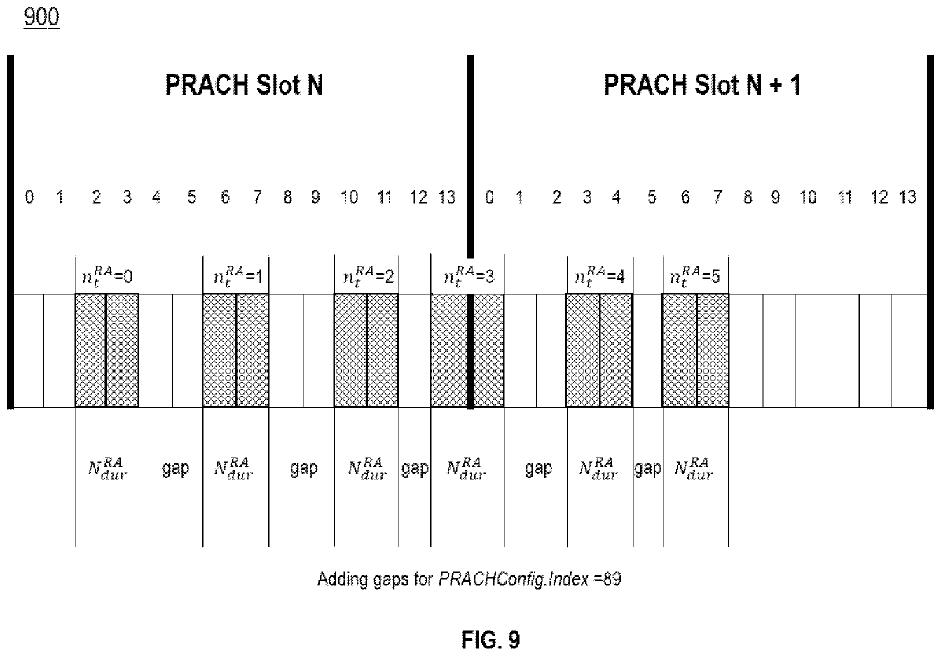

In some embodiments, a gap with a length of one symbol and/or another gap with a length of one or two symbols (as shown in FIG. 9) can be used, included, and/or introduced into a PRACH pattern/configuration, wherein the PRACH pattern is determined/specified by the value of the PRACH Config. Index (e.g., PRACH Config. Index=89). If one or more gaps with lengths of one or two symbols are used and/or a PRACH Config. Index has a value of 89, at least one RO (for instance, a fifth RO and/or a sixth RO) may be located beyond and/or outside of a first PRACH slot (e.g., slot N). For instance, the at least one RO can be located in a second PRACH slot (e.g., slot N+1) following (e.g., immediately following, or more than one slot away) the first PRACH slot. If one or more gaps with lengths of one or two symbols are used and/or a PRACH Config. Index has a value of 89, a fourth RO may straddle and/or extend across a PRACH slot boundary. The PRACH slot boundary can be a PRACH slot boundary between a first PRACH slot (e.g., slot N) and a second PRACH slot (e.g., slot N+1).

### I. For the Fourth RO

Case 1: In some embodiments, a wireless communication device may determine that the fourth RO (and/or other ROs straddling a PRACH slot boundary) is valid. For instance, if the second PRACH slot (e.g., slot N+1) is an UL slot and/or the symbol(s) of the second PRACH slot occupied/used by the fourth RO is/are UL symbol(s), the wireless communication device may determine that the fourth RO is valid.
Case 1-1: In some embodiments, the wireless communication device may determine that the fourth RO (and/or other ROs straddling a PRACH slot boundary) is valid if at least the second PRACH slot is an UL slot. In some embodiments, the wireless communication device may determine that the fourth RO is valid if at least the symbol(s) of the second PRACH slot occupied/used by the fourth RO is/are UL symbol(s). In some embodiments, the wireless communication device may determine the fourth RO is valid if a first symbol of the fourth RO is at least N_{gap} symbols after a last DL symbol. In some embodiments, the wireless communication device may determine that the fourth RO is valid if a first symbol of the fourth RO is at least N_{gap} symbols after a last SS/PBCH block symbol. In some embodiments, N_{gap} can include or correspond to an integer value greater than or equal to 0 (or other values).
Case 1-2: In some embodiments, the wireless communication device may determine that the fourth RO (and/or other ROs straddling a PRACH slot boundary) is invalid if at least the second PRACH slot is an UL slot. In some embodiments, the wireless communication device may determine that the fourth RO is invalid if at least the symbol(s) of the second PRACH slot occupied/used by the fourth RO is/are UL symbol(s). In some embodiments, the wireless communication device may determine that the fourth RO is invalid if a first symbol of the fourth RO is less than N_{gap} symbols after a last DL symbol. In some embodiments, the wireless communication device may determine that the fourth RO is invalid if a first symbol of the fourth RO is less than N_{gap} symbols after a last SS/PBCH block symbol. In some embodiments, N_{gap} can include or correspond to an integer value greater than or equal to 0 (or other values).
Case 2: In some embodiments, a wireless communication device may determine that the fourth RO (and/or other ROs straddling a PRACH slot boundary) is invalid. For instance, if the second PRACH slot (e.g., slot N+1) is a DL slot and/or any of the symbol(s) of the second PRACH slot occupied/used by the fourth RO is/are DL symbol(s), the wireless communication device may determine that the fourth RO is invalid.
Case 3: In some embodiments, a wireless communication device may determine that the fourth RO (and/or other ROs straddling a PRACH slot boundary) is valid. In some embodiments, a wireless communication device may combine/use Case 1-1 and Case 3 to determine whether the fourth RO is valid.
Case 4: In some embodiments, a wireless communication device may determine that the fourth RO (and/or other ROs straddling a PRACH slot boundary) is invalid. For instance, the wireless communication device may determine that the fourth RO is invalid if the fourth RO straddles a PRACH slot boundary (e.g., the fourth RO spans across a first PRACH slot and a second PRACH slot).

### II. For the Fifth and Sixth ROs

Case 1: In some embodiments, a wireless communication device may determine that at least one RO (e.g., a fifth RO, a sixth RO, and/or other ROs located beyond and/or outside of a first PRACH slot) is valid. For instance, if the second PRACH slot (e.g., slot N+1) is an UL slot and/or the symbol(s) of the second PRACH slot occupied/used by the at least one RO is/are UL symbol(s), the wireless communication device may determine that the at least one RO is valid.
Case 1-1: In some embodiments, the wireless communication device may determine that the at least one RO (e.g., a fifth RO, a sixth RO, and/or other ROs located beyond and/or outside of a first PRACH slot) is valid if at least the second PRACH slot is an UL slot. In some embodiments, the wireless communication device may determine that the at least one RO (e.g., a fifth RO, a sixth RO, and/or other ROs located beyond and/or outside of a first PRACH slot) is valid if at least the symbol(s) of the second PRACH slot occupied/used by the at least one RO is/are UL symbol(s). In some embodiments, the wireless communication device may determine that the at least one RO is valid if a first symbol of the at least one RO is at least N_{gap} symbols after a last DL symbol. In some embodiments, the wireless communication device may determine that the at least one RO is valid if a first symbol of the at least one RO is at least N_{gap} symbols after a last SS/PBCH block symbol. In some embodiments, N_{gap} can include or correspond to an integer value greater than or equal to 0 (or other values).
Case 1-2: In some embodiments, the wireless communication device may determine that the at least one RO (e.g., a fifth RO, a sixth RO, and/or other ROs located beyond and/or outside of a first PRACH slot) is invalid if at least the second PRACH slot is an UL slot. In some embodiments, the wireless communication device may determine that the at least one RO (e.g., a fifth RO, a sixth RO, and/or other ROs located beyond and/or outside of a first PRACH slot) is invalid if at least the symbol(s) of the second PRACH slot occupied/used by the third RO is/are UL symbol(s). In some embodiments, the wireless communication device may determine that the at least one RO is invalid if a first symbol of the at least one RO is less than N_{gap} symbols after a last DL symbol. In some embodiments, the wireless communication device may determine that the at least one RO is invalid if a first symbol of the at least one RO is less than N_{gap} symbols after a last SS/PBCH block symbol. In some embodiments, N_{gap} can include or correspond to an integer value greater than or equal to 0 (or other values).
Case 2: In some embodiments, a wireless communication device may determine that the at least one RO (e.g., a fifth RO, a sixth RO, and/or other ROs located beyond and/or outside of a first PRACH slot) is invalid. For instance, if the second PRACH slot (e.g., slot N+1) is a DL slot and/or any of the symbol(s) of the second PRACH slot occupied/used by the at least one RO is/are DL symbol(s), the wireless communication device may determine that the at least one RO is invalid.
Case 3: In some embodiments, a wireless communication device may determine that the at least one RO (e.g., a fifth RO, a sixth RO, and/or other ROs located beyond and/or outside of a first PRACH slot) is valid. In some embodiments, a wireless communication device may combine/use Case 1-1 and Case 3 to determine whether the at least one RO is valid.
Case 4: In some embodiments, a wireless communication device may determine that the at least one RO (e.g., a fifth RO, a sixth RO, and/or other ROs located beyond and/or outside of a first PRACH slot) is invalid. For instance, the wireless communication device may determine that the at least one RO is invalid if the at least one RO is located in a slot other than the first PRACH slot (e.g., the at least one RO is entirely located in a slot other than the first PRACH slot).

### C. Validation of a Random Access Channel Occasion

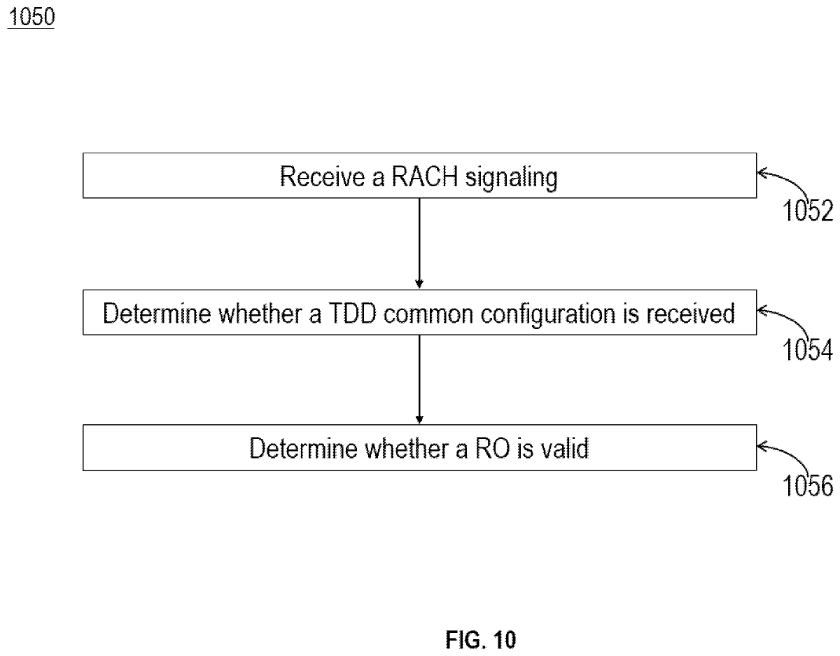

FIG. 10 illustrates a flow diagram of a method 1050 for determining validity of a RO. The method 1050 may be implemented using any of the components and devices detailed herein in conjunction with FIGS. 1-9. In overview, the method 1050 may include receiving a RACH signaling (1052). The method 1050 may include determining whether a TDD common configuration is received (1054). The method 1050 may include determining whether a RO is valid (1056).

Referring now to operation (1052), and in some embodiments, a wireless communication device (e.g., a UE) may receive and/or obtain a RACH signaling. For instance, the wireless communication node (e.g., a BS) may send, transmit, communicate, and/or broadcast a RACH signaling (and/or other types of signaling) to the wireless communication device. The wireless communication device may receive and/or obtain the RACH signaling from the wireless communication node. In one example, the wireless communication device may receive a PRACH Configuration Index (e.g., PRACH Config. Index) and/or other information from the wireless communication node via the RACH signaling. As such, the RACH signaling can be used to provide, specify, and/or indicate the PRACH Configuration Index and/or other information to the wireless communication device.

Referring now to operation (1054), and in some embodiments, the wireless communication device may determine and/or identify whether a TDD common configuration (e.g., tdd-UL-DL-ConfigurationCommon) is received/obtained at the wireless communication device. The TDD common configuration can indicate and/or specify whether one or more slots and/or symbols can be used for UL transmissions and/or DL transmissions. For instance, if a TDD common configuration is received/obtained at the wireless communication device, one or more slots and/or symbols can be used for both UL transmissions and DL transmissions (e.g., flexible configuration of slots and/or symbols). If, for example, a TDD common configuration is not received/obtained at the wireless communication device, the one or more slots and/or symbols may only be used for UL transmissions or DL transmissions.

Referring now to operation (1056), and in some embodiments, the wireless communication device may determine whether a RO is valid. For instance, the wireless communication device may determine whether a RO is valid (or invalid) according to (or based on) a reception of the TDD common configuration. In some embodiments, the wireless communication device may determine whether a RO is valid (or invalid) if the TDD common configuration is received. In some embodiments, the wireless communication device may determine and/or identify whether the RO is valid (or invalid), if no TDD common configuration is received. If, for instance, no TDD common configuration is received, one or more slots and/or symbols may be configured to be flexible (e.g., configured to be used for both UL and DL transmissions). In some embodiments, a RO may straddle, span, and/or extend across a PRACH slot boundary/bound. The PRACH slot boundary can include or correspond to a slot boundary between a first PRACH slot (e.g., slot N) and a second PRACH slot. The second PRACH slot may follow/succeed the first PRACH slot (e.g., slot N+1 and/or other slots following the first PRACH slot). When a RO straddles the PRACH slot boundary, the wireless communication device may determine the RO is valid or invalid. For instance, the wireless communication device may determine the RO is invalid if at least one symbol of the RO is in a PRACH slot (e.g., slot N+1) other than a first PRACH slot (e.g., slot N).

In some embodiments, the wireless communication device may determine the RO is valid if one or more conditions are met/satisfied. For instance, the wireless communication device may determine that the RO (e.g., the RO straddling the PRACH slot boundary) is valid if the second PRACH slot is an UL slot and/or each symbol occupied by the RO in the second slot is an UL symbol. In one example, the wireless communication device may determine that the RO is valid if the RO has a first symbol in the first PRACH slot and/or each symbol occupied by the RO in the second PRACH slot is an UL symbol. For instance, the RO may have one or more symbols in a first PRACH slot and/or one or more UL symbols in a second PRACH slot. As such, the wireless communication device may determine that the RO is valid. In some embodiments, the wireless communication device may determine that the RO is valid if a first symbol of the RO is at least N_{gap} symbols after a last DL symbol, and/or at least N_{gap} symbols after a last SS/PBCH block symbol. For instance, if the first symbol of the RO is at least 2 (or other values) symbols (e.g., 4 symbols and/or other number of symbols) after the last DL symbol and at least 2 symbols (e.g., 3 symbols and/or other values) after the last SS/PBCH block symbol, the wireless communication device may determine the RO is valid. In some embodiments, N_{gap} may indicate, specify, provide, and/or include an integer value greater than or equal to 0 (or other values).

In some embodiments, the wireless communication device may determine that the RO is invalid if one or more conditions are met/satisfied. For instance, if the second PRACH slot is a DL slot and/or any symbol occupied by the RO (e.g., the RO straddling the boundary) in the second PRACH slot is a DL symbol, the wireless communication device may determine that the RO is invalid. In one example, a first symbol of the RO is less than N_{gap} symbols after a last DL symbol (or other symbols), and/or a last SS/PBCH block symbol. If the first symbol of the RO is less than N_{gap} symbols after a last DL symbol and/or a last SS/PBCH block symbol, the wireless communication device may determine the RO is invalid. For example, the RO can be invalid if the RO is less than 3 (or other values) symbols after the last DL symbol (e.g., 1 symbol after a last DL symbol) or less than 3 symbols after a last SS/PBCH block symbol (e.g., 2 symbols after a last SS/PBCH block symbol). In some embodiments, the wireless communication device may determine that the RO is invalid if the RO has a first symbol in the first PRACH slot and/or any symbol occupied by the RO in the second PRACH slot (e.g., the last PRACH slot) is a DL symbol.

In some embodiments, the RO may be located, situated, and/or positioned beyond a first PRACH slot. For instance, the RO may be located in a second PRACH slot following the first PRACH slot (e.g., immediately following the first PRACH slot and/or at least two slots away). When the RO is located beyond the first PRACH slot, the wireless communication device may determine that the RO is valid or invalid. If the second PRACH slot (e.g., following the first PRACH slot) is an UL slot, for example, and/or each symbol occupied by the RO in the second PRACH slot is an UL symbol, the wireless communication device may determine that the RO (e.g., the RO located beyond first PRACH slot) is valid. In one example, the wireless communication device may determine that the RO is valid if a first symbol of the RO is at least N_{gap} (e.g., integer value greater than or equal to 0) symbols after a last DL symbol (or other symbols). In some embodiments, the wireless communication device may determine that the RO is valid if a first symbol of the RO is at least N_{gap} symbols after a last SS/PBCH block symbol (or other symbols). For example, if the first symbol of the RO (e.g., the RO located beyond the first PRACH slot) is at least 2 symbols (or other number of symbols) after a last DL symbol and at least 2 symbols (e.g., 4 symbols) after a last SS/PBCH block symbol, the wireless communication device may determine that the RO is valid.

In some embodiments, the wireless communication device may determine that the RO is invalid. For instance, if a first symbol of the RO is less than N_{gap} symbols (e.g., 2 symbols or other number of symbols) after a last DL symbol (or other symbols), the wireless communication device may determine that the RO is invalid. In one example, the wireless communication device may determine that the RO is invalid if a first symbol of the RO is less than N_{gap} symbols (e.g., 2 symbols or other number of symbols) after a last SS/PBCH block symbol (or other symbols). In some embodiments, if the second PRACH slot is a DL slot, and/or any symbol occupied by the RO in the second slot is a DL symbol, the wireless communication device may determine that the RO (e.g., the RO located beyond the first PRACH slot) is invalid.

While various embodiments of the present solution have been described above, it should be understood that they have been presented by way of example only, and not by way of limitation. Likewise, the various diagrams may depict an example architectural or configuration, which are provided to enable persons of ordinary skill in the art to understand example features and functions of the present solution. Such persons would understand, however, that the solution is not restricted to the illustrated example architectures or configurations, but can be implemented using a variety of alternative architectures and configurations. Additionally, as would be understood by persons of ordinary skill in the art, one or more features of one embodiment can be combined with one or more features of another embodiment described herein. Thus, the breadth and scope of the present disclosure should not be limited by any of the above-described illustrative embodiments.

It is also understood that any reference to an element herein using a designation such as “first,” “second,” and so forth does not generally limit the quantity or order of those elements. Rather, these designations can be used herein as a convenient means of distinguishing between two or more elements or instances of an element. Thus, a reference to first and second elements does not mean that only two elements can be employed, or that the first element must precede the second element in some manner.

Additionally, a person having ordinary skill in the art would understand that information and signals can be represented using any of a variety of different technologies and techniques. For example, data, instructions, commands, information, signals, bits and symbols, for example, which may be referenced in the above description can be represented by voltages, currents, electromagnetic waves, magnetic fields or particles, optical fields or particles, or any combination thereof.

A person of ordinary skill in the art would further appreciate that any of the various illustrative logical blocks, modules, processors, means, circuits, methods and functions described in connection with the aspects disclosed herein can be implemented by electronic hardware (e.g., a digital implementation, an analog implementation, or a combination of the two), firmware, various forms of program or design code incorporating instructions (which can be referred to herein, for convenience, as “software” or a “software module), or any combination of these techniques. To clearly illustrate this interchangeability of hardware, firmware and software, various illustrative components, blocks, modules, circuits, and steps have been described above generally in terms of their functionality. Whether such functionality is implemented as hardware, firmware or software, or a combination of these techniques, depends upon the particular application and design constraints imposed on the overall system. Skilled artisans can implement the described functionality in various ways for each particular application, but such implementation decisions do not cause a departure from the scope of the present disclosure.

Furthermore, a person of ordinary skill in the art would understand that various illustrative logical blocks, modules, devices, components and circuits described herein can be implemented within or performed by an integrated circuit (IC) that can include a general purpose processor, a digital signal processor (DSP), an application specific integrated circuit (ASIC), a field programmable gate array (FPGA) or other programmable logic device, or any combination thereof. The logical blocks, modules, and circuits can further include antennas and/or transceivers to communicate with various components within the network or within the device. A general purpose processor can be a microprocessor, but in the alternative, the processor can be any conventional processor, controller, or state machine. A processor can also be implemented as a combination of computing devices, e.g., a combination of a DSP and a microprocessor, a plurality of microprocessors, one or more microprocessors in conjunction with a DSP core, or any other suitable configuration to perform the functions described herein.

If implemented in software, the functions can be stored as one or more instructions or code on a computer-readable medium. Thus, the steps of a method or algorithm disclosed herein can be implemented as software stored on a computer-readable medium. Computer-readable media includes both computer storage media and communication media including any medium that can be enabled to transfer a computer program or code from one place to another. A storage media can be any available media that can be accessed by a computer. By way of example, and not limitation, such computer-readable media can include RAM, ROM, EEPROM, CD-ROM or other optical disk storage, magnetic disk storage or other magnetic storage devices, or any other medium that can be used to store desired program code in the form of instructions or data structures and that can be accessed by a computer.

In this document, the term “module” as used herein, refers to software, firmware, hardware, and any combination of these elements for performing the associated functions described herein. Additionally, for purpose of discussion, the various modules are described as discrete modules; however, as would be apparent to one of ordinary skill in the art, two or more modules may be combined to form a single module that performs the associated functions according embodiments of the present solution.

Additionally, memory or other storage, as well as communication components, may be employed in embodiments of the present solution. It will be appreciated that, for clarity purposes, the above description has described embodiments of the present solution with reference to different functional units and processors. However, it will be apparent that any suitable distribution of functionality between different functional units, processing logic elements or domains may be used without detracting from the present solution. For example, functionality illustrated to be performed by separate processing logic elements, or controllers, may be performed by the same processing logic element, or controller. Hence, references to specific functional units are only references to a suitable means for providing the described functionality, rather than indicative of a strict logical or physical structure or organization.

Various modifications to the embodiments described in this disclosure will be readily apparent to those skilled in the art, and the general principles defined herein can be applied to other embodiments without departing from the scope of this disclosure. Thus, the disclosure is not intended to be limited to the embodiments shown herein, but is to be accorded the widest scope consistent with the novel features and principles disclosed herein, as recited in the claims below.

1. A method comprising:
receiving, by a wireless communication device from a wireless communication node, a random access channel (RACH) signaling; and
determining, by the wireless communication device, whether a time-division duplex (TDD) common configuration is received at the wireless communication device.

2. The method of claim 1, comprising:
determining, by the wireless communication device, whether a RACH occasion (RO) is valid if the TDD common configuration is received; or
determining, by the wireless communication device, whether the RO is valid, if no TDD common configuration is received.

3. The method of claim 2, wherein when the RO straddles a physical RACH (PRACH) slot boundary between a first PRACH slot and a second PRACH slot following the first PRACH slot, and the method comprises:
determining, by the wireless communication device, that the RO is valid if at least one of:
the second PRACH slot is an uplink (UL) slot or each symbol occupied by the RO in the second slot is an UL symbol; or
the RO has a first symbol in the first PRACH slot and each symbol occupied by the RO in the second PRACH slot is an UL symbol; or
a first symbol of the RO is at least N_{gap} symbols after a last downlink (DL) symbol, and at least N_{gap} symbols after a last synchronization signal or physical broadcast channel (SS/PBCH) block symbol, where N_{gap} is an integer value greater than or equal to 0;
determining, by the wireless communication device, that the RO is invalid if at least one of:
the second PRACH slot is a DL slot or any symbol occupied by the RO in the second slot is a DL symbol; or
a first symbol of the RO is less than N_{gap} symbols after a last DL symbol, or less than N_{gap} symbols after a last synchronization signal or physical broadcast channel (SS/PBCH) block symbol; or
the RO has a first symbol in the first PRACH slot and any symbol occupied by the RO in the second PRACH slot is a DL symbol;
determining, by the wireless communication device, that the RO is valid; or
determining, by the wireless communication device, that the RO is invalid.

4. The method of claim 2, wherein when the RO is located beyond a first physical RACH (PRACH) slot in a second PRACH slot following the first PRACH slot, and the method comprises:
determining, by the wireless communication device, that the RO is valid if at least one of:
the second PRACH slot is an uplink (UL) slot or each symbol occupied by the RO in the second slot is an UL symbol; or
a first symbol of the RO is at least N_{gap} symbols after a last downlink (DL) symbol, and at least N_{gap} symbols after a last synchronization signal or physical broadcast channel (SS/PBCH) block symbol, where N_{gap} is an integer value greater than or equal to 0; or
determining, by the wireless communication device, that the RO is invalid if at least one of:
a first symbol of the RO is less than N_{gap} symbols after a last DL symbol, or less than N_{gap} symbols after a last SS/PBCH block symbol; or
the second PRACH slot is a DL slot or any symbol occupied by the RO in the second slot is a DL symbol; or
determining, by the wireless communication device, that the RO is valid; or
determining, by the wireless communication device, that the RO is invalid.

5. A method comprising:
transmitting, by a wireless communication node to a wireless communication device, a random access channel (RACH) signaling;
wherein the wireless communication device determines whether a RACH occasion (RO) is valid if a time-division duplex (TDD) common configuration is received, or
wherein the wireless communication device determines whether the RO is valid if no TDD common configuration is received.

6. The method of claim 5, wherein:
the wireless communication device determines whether a RACH occasion (RO) is valid if the TDD common configuration is received; or
the wireless communication device determines whether the RO is valid, if no TDD common configuration is received.

7. The method of claim 6, wherein when the RO straddles a physical RACH (PRACH) slot boundary between a first PRACH slot and a second PRACH slot following the first PRACH slot:
the wireless communication device determines that the RO is valid if at least one of:
the second PRACH slot is an uplink (UL) slot or each symbol occupied by the RO in the second slot is an UL symbol; or
the RO has a first symbol in the first PRACH slot and each symbol occupied by the RO in the second PRACH slot is an UL symbol; or
a first symbol of the RO is at least N_{gap} symbols after a last downlink (DL) symbol, and at least N_{gap} symbols after a last synchronization signal or physical broadcast channel (SS/PBCH) block symbol, where N_{gap} is an integer value greater than or equal to 0;
the wireless communication device determines that the RO is invalid if at least one of:
the second PRACH slot is a DL slot or any symbol occupied by the RO in the second slot is a DL symbol; or
a first symbol of the RO is less than N_{gap} symbols after a last DL symbol, or less than N_{gap} symbols after a last synchronization signal or physical broadcast channel (SS/PBCH) block symbol; or
the RO has a first symbol in the first PRACH slot and any symbol occupied by the RO in the second PRACH slot is a DL symbol;
the wireless communication device determines that the RO is valid; or
the wireless communication device determines that the RO is invalid.

8. The method of claim 6, wherein when the RO is located beyond a first physical RACH (PRACH) slot in a second PRACH slot following the first PRACH slot:
the wireless communication device determines that the RO is valid if at least one of:
the second PRACH slot is an uplink (UL) slot or each symbol occupied by the RO in the second slot is an UL symbol; or
a first symbol of the RO is at least N_{gap} symbols after a last downlink (DL) symbol, and at least N_{gap} symbols after a last synchronization signal or physical broadcast channel (SS/PBCH) block symbol, where N_{gap} is an integer value greater than or equal to 0; or
the wireless communication device determines that the RO is invalid if at least one of:
a first symbol of the RO is less than N_{gap} symbols after a last DL symbol, or less than N_{gap} symbols after a last SS/PBCH block symbol; or
the second PRACH slot is a DL slot or any symbol occupied by the RO in the second slot is a DL symbol; or
the wireless communication device determines that the RO is valid; or
the wireless communication device determines that the RO is invalid.

9. A wireless communication device, comprising:
at least one processor configured to:
receive, via a receiver from a wireless communication node, a random access channel (RACH) signaling; and
determine whether a time-division duplex (TDD) common configuration is received at the wireless communication device.

10. The wireless communication device of claim 9, wherein the at least one processor is configured to:
determine whether a RACH occasion (RO) is valid if the TDD common configuration is received; or
determine whether the RO is valid, if no TDD common configuration is received.

11. The wireless communication device of claim 10, wherein when the RO straddles a physical RACH (PRACH) slot boundary between a first PRACH slot and a second PRACH slot following the first PRACH slot, at least one processor is configured to:
determine that the RO is valid if at least one of:
the second PRACH slot is an uplink (UL) slot or each symbol occupied by the RO in the second slot is an UL symbol; or
the RO has a first symbol in the first PRACH slot and each symbol occupied by the RO in the second PRACH slot is an UL symbol; or
a first symbol of the RO is at least N_{gap} symbols after a last downlink (DL) symbol, and at least N_{gap} symbols after a last synchronization signal or physical broadcast channel (SS/PBCH) block symbol, where N_{gap} is an integer value greater than or equal to 0;
determine that the RO is invalid if at least one of:
the second PRACH slot is a DL slot or any symbol occupied by the RO in the second slot is a DL symbol; or
a first symbol of the RO is less than N_{gap} symbols after a last DL symbol, or less than N_{gap} symbols after a last synchronization signal or physical broadcast channel (SS/PBCH) block symbol; or
the RO has a first symbol in the first PRACH slot and any symbol occupied by the RO in the second PRACH slot is a DL symbol;
determine that the RO is valid; or
determine that the RO is invalid.

12. The wireless communication device of claim 10, wherein when the RO is located beyond a first physical RACH (PRACH) slot in a second PRACH slot following the first PRACH slot, the at least one processor is configured to:
determine that the RO is valid if at least one of:
the second PRACH slot is an uplink (UL) slot or each symbol occupied by the RO in the second slot is an UL symbol; or
a first symbol of the RO is at least N_{gap} symbols after a last downlink (DL) symbol, and at least N_{gap} symbols after a last synchronization signal or physical broadcast channel (SS/PBCH) block symbol, where N_{gap} is an integer value greater than or equal to 0; or
determine that the RO is invalid if at least one of:
a first symbol of the RO is less than N_{gap} symbols after a last DL symbol, or less than N_{gap} symbols after a last SS/PBCH block symbol; or
the second PRACH slot is a DL slot or any symbol occupied by the RO in the second slot is a DL symbol; or
determine that the RO is valid; or
determine that the RO is invalid.

13. A wireless communication node, comprising:
at least one processor configured to:
transmit, via a transmitter to a wireless communication device, a random access channel (RACH) signaling;
wherein the wireless communication device determines whether a RACH occasion (RO) is valid if a time-division duplex (TDD) common configuration is received, or
wherein the wireless communication device determines whether the RO is valid if no TDD common configuration is received.

14. The wireless communication node of claim 13, wherein:
the wireless communication device determines whether a RACH occasion (RO) is valid if the TDD common configuration is received; or
the wireless communication device determines whether the RO is valid, if no TDD common configuration is received.

15. The wireless communication node of claim 14, wherein when the RO straddles a physical RACH (PRACH) slot boundary between a first PRACH slot and a second PRACH slot following the first PRACH slot:
the wireless communication device determines that the RO is valid if at least one of:
the second PRACH slot is an uplink (UL) slot or each symbol occupied by the RO in the second slot is an UL symbol; or
the RO has a first symbol in the first PRACH slot and each symbol occupied by the RO in the second PRACH slot is an UL symbol; or
a first symbol of the RO is at least N_{gap} symbols after a last downlink (DL) symbol, and at least N_{gap} symbols after a last synchronization signal or physical broadcast channel (SS/PBCH) block symbol, where N_{gap} is an integer value greater than or equal to 0;
the wireless communication device determines that the RO is invalid if at least one of:
the second PRACH slot is a DL slot or any symbol occupied by the RO in the second slot is a DL symbol; or
a first symbol of the RO is less than N_{gap} symbols after a last DL symbol, or less than N_{gap} symbols after a last synchronization signal or physical broadcast channel (SS/PBCH) block symbol; or
the RO has a first symbol in the first PRACH slot and any symbol occupied by the RO in the second PRACH slot is a DL symbol;
the wireless communication device determines that the RO is valid; or
the wireless communication device determines that the RO is invalid.

16. The wireless communication node of claim 14, wherein when the RO is located beyond a first physical RACH (PRACH) slot in a second PRACH slot following the first PRACH slot:
the wireless communication device determines that the RO is valid if at least one of:
the second PRACH slot is an uplink (UL) slot or each symbol occupied by the RO in the second slot is an UL symbol; or
a first symbol of the RO is at least N_{gap} symbols after a last downlink (DL) symbol, and at least N_{gap} symbols after a last synchronization signal or physical broadcast channel (SS/PBCH) block symbol, where N_{gap} is an integer value greater than or equal to 0; or
the wireless communication device determines that the RO is invalid if at least one of:
a first symbol of the RO is less than N_{gap} symbols after a last DL symbol, or less than N_{gap} symbols after a last SS/PBCH block symbol; or
the second PRACH slot is a DL slot or any symbol occupied by the RO in the second slot is a DL symbol; or
the wireless communication device determines that the RO is valid; or
the wireless communication device determines that the RO is invalid.

17. A non-transitory computer readable medium storing instructions, which when executed by at least one processor, cause the at least one processor to perform the method of claim 1.

18. A non-transitory computer readable medium storing instructions, which when executed by at least one processor, cause the at least one processor to perform the method of claim 2.

19. A non-transitory computer readable medium storing instructions, which when executed by at least one processor, cause the at least one processor to perform the method of claim 9.

20. A non-transitory computer readable medium storing instructions, which when executed by at least one processor, cause the at least one processor to perform the method of claim 10.
